(19) United States
(12) Patent Application Publication
(10) Pub. No.: US 2016/0152299 A1
(43) Pub. Date: Jun. 2, 2016

(54) BICYCLE CONTROL DEVICE

(71) Applicant: AD-II ENGINEERING INC., Taichung City (TW)

(72) Inventor: Hsueh-Chih MU, Taichung City (TW)

(21) Appl. No.: 15/015,163

(22) Filed: Feb. 4, 2016

Related U.S. Application Data
(63) Continuation-in-part of application No. 13/950,321, filed on Jul. 25, 2013, now abandoned.

(30) Foreign Application Priority Data
Jan. 10, 2013 (TW) 102100948

(51) Int. Cl. B62L 3/02; B62M 25/04

(52) U.S. Cl. CPC B62L 3/02; B62M 25/04

(57) ABSTRACT

A bicycle control device of the present invention includes a supporting member, a brake lever pivotally connected to a pivot axle mounted in the supporting member, and an electrical shift control unit, which includes an operating lever mounted in the pivot axle, and an input module on the operating lever. The electrical shift control unit has the advantages of excellent structural stability and high durability, and enables the bicycle rider to control gear shifting of the bicycle by means of the input module.

### CROSS-REFERENCE TO RELATED APPLICATION

This patent application is a continuation-in-part of U.S. patent application Ser. No. 13/950,321 filed Jul. 25, 2013 entitled “BICYCLE CONTROL DEVICE”, the entire disclosure of which is incorporated herein by reference.

### BACKGROUND OF THE INVENTION

1. Field of the Invention

The present invention relates to a bicycle mechanism and more particularly, to a bicycle control device for conveniently gear shifting of a derailleur, having the advantages of excellent structural stability and high durability.

2. Description of the Related Art

With the ever rising of the energy price, bicycle riding has become the most popular pastime, sports and transportation method. For the purpose of riding comfort, the ability of gear changing has become the basic and one of the most desirable functions of a bicycle.

Conventionally, the control of a derailleur of a bicycle is achieved by means of pulling a derailleur cable mechanically. In other words, a control lever is mounted adjacent to the brake lever for manual operation by the bicycle rider. With the help of the fast development of electronic control technology in recent years, some bicycle manufacturers started to install electronic switches in the brake lever for the control of the derailleur of the bicycle. U.S. Pat. No. 6,015,036, entitled “ELECTRICAL SHIFT CONTROL DEVICE FOR A BICYCLE TRANSMISSION”, discloses a bicycle control device. This design discloses the arrangement of the electrical shift control switches on the brake lever for finger operation. However, inherent in this design, the wires of the electrical shift control switches must be laid through the pivoting area of the brake lever. Thus, this design is not conducive to the wiring of the electrical shift control switches.

U.S. Pat. No. 6,073,730, entitled “BICYCLE SWITCH AND BRACKET COVER THEREFOR”, discloses another bicycle control device. According to this disclosure, the switches are mounted in a switch mounting recess of a brake member bracket which is for use in fastening the handlebar of the brake. Although such design contributes to solve the electrical wiring problem, the structural strength of the brake member bracket is sacrificed due to the switch mounting recess. Besides, such design also leads to poor ergonomics satisfaction.

U.S. Pat. No. 6,698,567 discloses yet another bicycle control device, entitled “ELECTRIC CONTROL DEVICE FOR A MOTOR-DRIVEN DERAILLEUR FOR BICYCLES”, which comprises: a supporting body provided with means for fixing it to a bicycle bracket, a brake control lever hinged to the supporting body, a pair of electric switches to control gear change carried by the supporting body, and a gear change lever that can be operated manually to control at least one of the switches. Even though such bicycle control device satisfies ergonomic criteria and solves the electrical wiring problem, complicate structure and lowered durability just become other problems thereof.

U.S. Pat. No. 7,947,914 discloses another bicycle control device entitled “BICYCLE SHIFT OPERATING DEVICE” , which comprises: a mounting part assembles with a brake lever, two operating members integrate with the brake lever, and a first signal generator installs in a support body of the brake lever. The first signal generator generates a signal for changing a shift position of the bicycle shift operating device in response to the operating members. The operating members are difficult to use and maybe easily pushed by accident.

U.S. Pat. No. 6,015,036 disclose another bicycle control device entitled “ELECTRICAL SHIFT CONTROL DEVICE FOR A BICYCLE TRANSMISSION”, which comprises: two electrical shift control switches mounted on a brake lever adapted to move relative to a handlebar. The control switches are easy to wrong operation during braking process, and maybe damage when the bicycle accidently falls down.

### SUMMARY OF THE INVENTION

The present invention has been accomplished under the circumstances in view. It is the main object of the present invention to provide a bicycle control device, which can be firmly mounted in the bicycle handlebar and is convenient in operation.

It is another object of the present invention to provide a bicycle control device, which has the advantages of simple structure, easy installation and high durability. Furthermore, it can avoid to damage when the bicycle accidently falls down.

To achieve these and other objects of the present invention, a bicycle control device is provided, which includes a supporting member, a brake lever movably connected to the supporting member, a pivot axle mounted between the supporting member and the brake lever, and an electrical control unit. The electrical control unit includes an operating lever pivotally connected to the pivot axle of the brake lever directly, and an input module connected to the operating lever. The input module having a main body extended from the operating lever along an inner side of the brake lever and configured to be driven by the brake lever to rotate about the pivot axle relative to the supporting member. The input module further having at least one press-button mounted on a surface of the main body for generating and transmitting a control signal.

Thus, the pivot axle of the bicycle control device enhances the structural strength of the control unit. By arranging the input module on the supporting member or at a suitable place adjacent to the brake lever, the bicycle rider can operate the input module with the hand to control gear shifting of the derailleur of the bicycle.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing in accordance with the embodiment of the present invention.

FIG. 2 is an exploded view in accordance with the embodiment of the present invention.

FIG. 3 is a schematic drawing, illustrating the relationship between the electrical shift control unit and the pivot axle in accordance with the embodiment of the present invention.

### DETAILED DESCRIPTION OF THE INVENTION

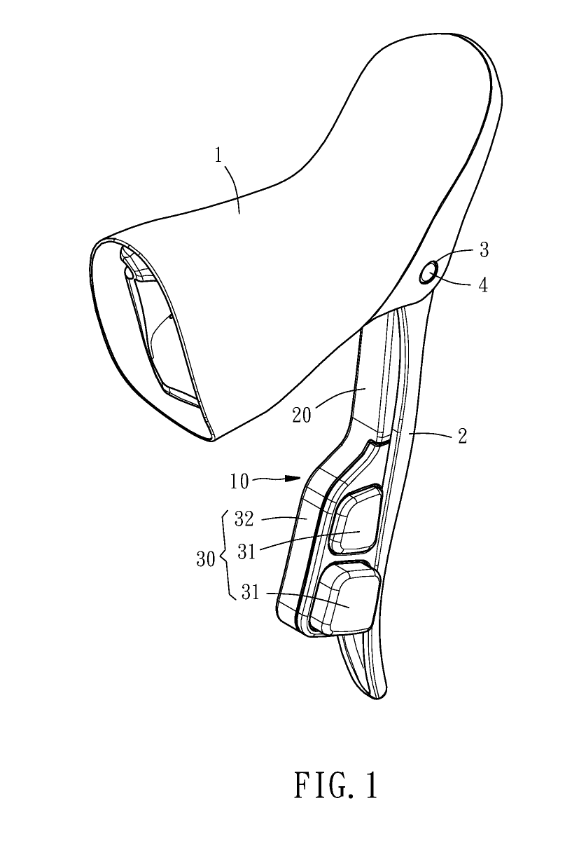

Please refer to FIGS. 1, the bicycle control device includes a supporting member 1 defining therein an axial bore 3, a brake lever 2 pivotally connected to the supporting member 1, and a pivot axle 4 mounted in the axial bore 3 of the supporting member 1 and works as the rotation axis of the brake lever 2. In this embodiment, the brake lever 2 is connected with a brake cable (not shown) for braking the bicycle.

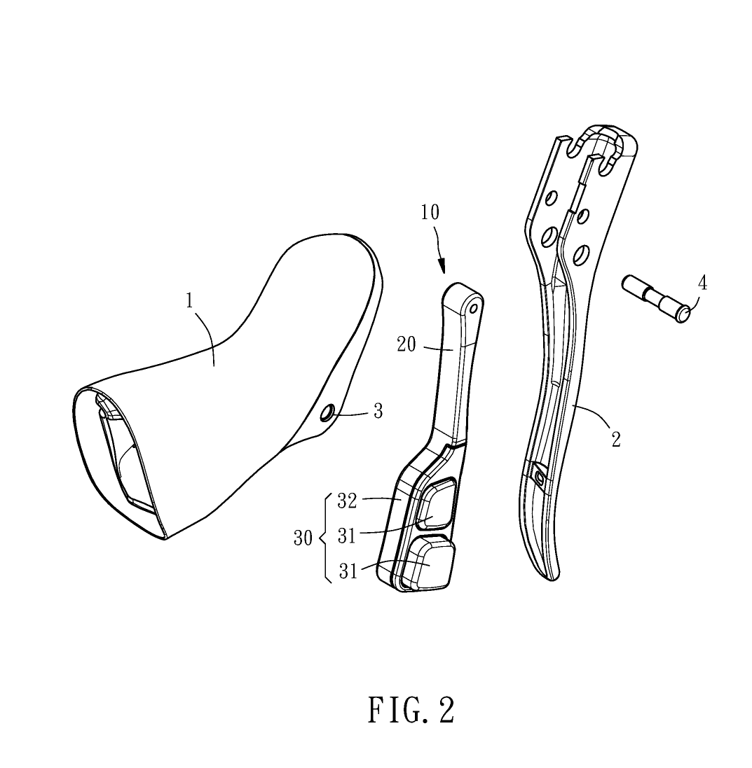

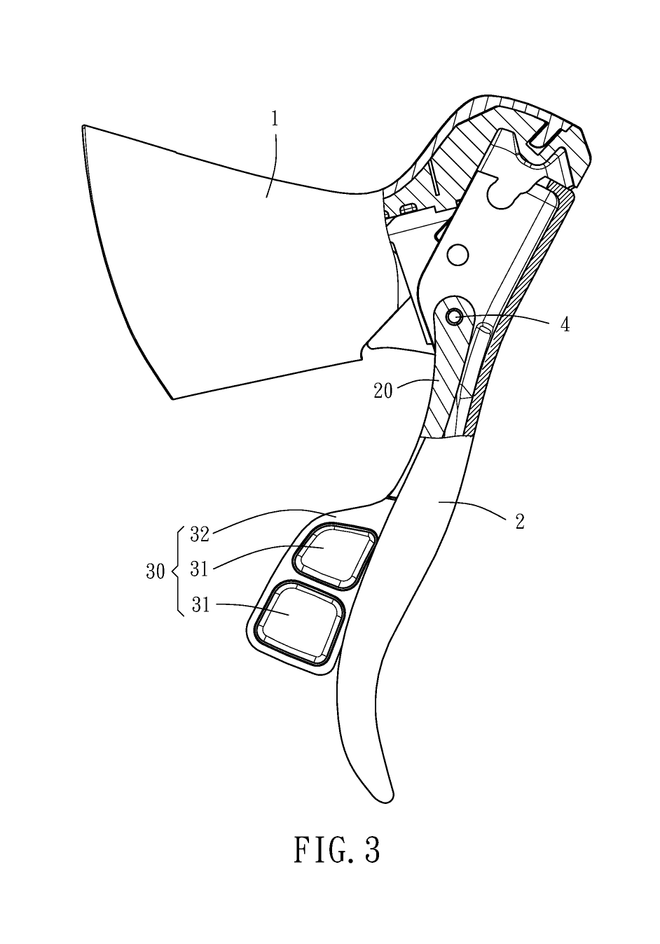

Please refer to FIGS. 1, 2 and 3; an electrical control unit 10 in accordance with an embodiment of the present invention comprises an operating lever 20, and an input module 30. The operating lever 20 is pivotally connected to the pivot axle 4 of the brake lever 2 directly and drivable by the brake lever 2 to move relative to the supporting member 1. The input module 30 includes a main body 32 extending from the operating lever 20 along an inner side of the brake lever 2 and rotatable about the pivot axle 4. The press-buttons 31 are mounted on a surface of the main body 32 for generating and transmitting a gear shifting control signal. For example, the press-buttons 31 are enabling bikers to make a gear shifting control by rotating the rotary buttons with the fingers.

Based on such design, the main body 32 can be moved with the brake lever 2 pressed by the bicycle rider. To shift the derailleur gears, the bicycle rider can operate the press-buttons 31 with fingers. Such arrangement of the buttons renders optimal operating convenience.

In conclusion, the operating lever of the present invention is directly mounted to a pivot axle of the brake lever. Such design occupies smaller space without sacrificing the structural strength thereof. Further, the present invention also enables a variety of arrangements of the input module and therefore renders better design flexibility for installation in any of a variety of bicycle control devices while conforming to ergonomics at the same time. When the bicycle falls down in accident, the brake lever will protect the input module of the bicycle control device.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bicycle control device, comprising:
a supporting member;
a brake lever pivotally connected to the supporting member by a pivot axle mounted in the supporting member; and
an electrical control unit, wherein the electrical control unit comprises:
an operating lever pivotally connected to the pivot axle of the brake lever directly and drivable by the brake lever to move relative to the supporting member; and
an input module having an main body extended from the operating lever along an inner side of the brake lever, wherein the main body is configured to be driven by the brake lever to rotate about the pivot axle relative to the supporting member; and
wherein the input module further comprises at least one press-button mounted on a surface of the main body for generating and transmitting a control signal.

2. The bicycle control device as claimed in claim 1, wherein the input module comprises two press-buttons.
